(19) United States
(12) Patent Application Publication
(10) Pub. No.: US 2016/0213003 A1
(43) Pub. Date: Jul. 28, 2016

(54) APPLICATION OF POLYOXOMETALATE IN PREPARATION OF DISINFECTANT FOR STERILIZING AND REMOVING FORMALDEHYDE

(71) Applicant: NINGBO YUCHEN ENVIROCLEAN TECH CO., LTD., Zhejiang (CN)

(72) Inventors: ZUOLIN ZHU, NINGBO, ZHEJIANG PROVINCE (CN); MENG SUN, NINGBO, ZHEJIANG PROVINCE (CN); ZHENJI ZHU, NINGBO, ZHEJIANG PROVINCE (CN); KANGFU GU, NINGBO, ZHEJIANG PROVINCE (CN); SHANQING SUN, NINGBO, ZHEJIANG PROVINCE (CN); TONGXING XIE, NINGBO, ZHEJIANG PROVINCE (CN); JIABAO ZHAO, NINGBO, ZHEJIANG PROVINCE (CN); WENHAI WANG, NINGBO, ZHEJIANG PROVINCE (CN)

(21) Appl. No.: 14/914,240

(22) PCT Filed: May 22, 2014
(86) PCT No.: PCT/CN2014/078083

§ 371 Date: Feb. 24, 2016

(30) Foreign Application Priority Data
Sep. 7, 2013 (CN) 201310405619.6

(51) Int. Cl. A01N 59/26; B01D 53/86

(52) U.S. Cl. CPC A01N 59/26; B01D 53/8668; B01D 2255/2022; B01D 2255/20776; B01D 2255/2027; B01D 2255/2045; B01D 2255/20769; B01D 2255/20723; B01D 2257/91; B01D 2257/708

(57) ABSTRACT

The present invention relates to an application of polyoxometalates with good water solubility in the preparation of disinfectant for sterilizing or removing formaldehyde. The present invention provides a sterilizing and disinfecting system utilizing oxygen in the air as an oxidizing agent, killing microorganisms via catalysis and oxidation, and particularly suitable for an air purification system. If the air is constantly introduced in, the disinfectant of the present invention can be used for a long time, without need of anti-viral drugs or peroxides having potential safety hazard, and without use of irritant substances containing halogen and alcohol having explosive hazard. Without using precious metals, the disinfectant system is easy to prepare and has low cost, dose not cause secondary pollution, and has a good application prospect.

### FIELD OF THE INVENTION

The present invention relates to an application of polyoxometalates in preparing a disinfectant for sterilizing or removing formaldehyde. The present invention provides a sterilizing and disinfecting system utilizing oxygen in the air as an oxidizing agent, killing microorganisms via catalysis and oxidation, and is particularly suitable for an air purification system.

### BACKGROUND OF THE INVENTION

With continuous increase of population density, the consumption of energy resource and chemical raw materials substantially increases, thereby causing gradual worsening of environmental pollution, particularly the air pollution, severely influencing human health. Air purification has become one of the most important top priority for human at present. How to realize purification of the air without secondary pollution at low application cost is the research and development emphasis of the scientific academia.

Air purification includes two aspects: the first is removing a variety of suspended particles in the air, and the second is removing the gas components harmful to human body in the air. The harmful gases include formaldehyde, sulfur oxides, nitrogen oxides, etc; the suspended particles include microorganisms such as viruses, pathogenic bacteria etc. To date, except for our research and development works, there is no any report about a system which is capable to both removing the formaldehyde and killing the pathogenic bacteria and viruses. The common measure for killing the pathogenic bacteria and viruses is using antibiotics and anti-viral drugs, or using a disinfectant containing halogen (e.g., sodium hypochlorite, or using peroxides (such as peroxy acids, peroxy alcohols, hydrogen peroxide, etc), or using small-molecule alcohols (e.g., ethanol, propanol), or using silver ion. These methods all cause the secondary pollution, and some methods also have big hidden risk of explosion (such as peroxides, small-molecule alcohols, etc). And removal of the formaldehyde is generally adsorbing the formaldehyde from the air using an adsorbent which is mainly an activated carbon via a passive mechanism. In many cases, these two measures cannot be utilized together, for example, if the activated carbon is used along with the peroxides, the activated carbon may catalyze fast degradation of the peroxides.

The brand new concept firstly proposed by the present inventors, wherein a safe and nontoxic substance is used as a catalyst, and the oxygen in the air is activated via a chemical catalysis, and the activated oxygen has a very potent ability of killing pathogenic bacteria and viruses, meanwhile the formaldehyde in the air is removed, its action mechanism being as shown in FIG. 1, provides a brand new research and development direction to meet the need of air purification for human. Under direction of this research and development concept, we have successfully developed a disinfection system of anthraquinone salts and a disinfection system of bisphenol salts. These two systems also have one shortcoming, i.e., in these two broad categories of compounds, some compounds have insufficient water solubility, and this may cause the required concentration of the disinfectant solution lower than the optimal concentration.

### SUMMARY OF THE INVENTION

The purpose of the present invention is to provide an application of polyoxometalates with high solubility in the preparation of a disinfectant for sterilizing and removing formaldehyde. The present invention provides a disinfectant system which can be used in air purification and has dual functions of killing viruses and pathogenic bacteria and removing formaldehyde.

The technical solution adopted by the present invention is: Application of polyoxometalatess in the preparation of the disinfectant; the anion of the polyoxometalates is [PW₁₂O₄₀]³⁻ or [PV₂Mo₁₀O₄₀]⁵⁻, and the cation is alkaline metal ion, alkaline earth metal ion, transition metal ion or ammonium ion. The cation of the polyoxometalates is preferably one of the following: potassium ion, sodium ion, ammonium ion, calcium ion, magnesium ion, copper ion, and iron ion.

The disinfection efficacy of the polyoxometalates is revealed under oxygen ventilation, thus, when used as the disinfectant, it is required to ventilate air continuously. Under normal operating condition for an air purifier (5 minutes or more, room temperature, a large amount of air being ventilated), the pathogenic bacteria and viruses can be effectively killed, in order to achieve the disinfection purpose, and obtain good efficacy of removing formaldehyde from the air.

Specifically, the disinfectant is a base solution prepared by dispersing the polyoxometalates into a solvent, and the pH is 8 to 12 (below this range, the disinfection effect will be poor; above this range, the solution will have a certain corrosion), in the presence of oxygen, an effective disinfection effect is obtained; the solvent is water, glycerol or a mixture thereof; the mass concentration of the polyoxometalates in the base solution is 0.5% to 15% (generally the mass concentration is no more than 10%, most preferably less than 5%, if the mass concentration is too high, the use cost will increase), such base solution may be directly used as the disinfectant, it may be also add some common additives and then used as the disinfectant, the additives include flavor and pigment etc, without specific limitation, as long as the purpose of the present invention is not influenced. The disinfectant product can be made into a form of liquid, slurry-like paste, and solid etc.

Preferably, the pH of the disinfectant of is 9.5 to 11, and the mass concentration of the polyoxometalates in the solution is 1% to 5%.

The disinfectant is primarily used for being added into the air purifier (for example, the disinfectant solution is put into an air inlet passage of the air purifier), for sterilizing and removing formaldehyde.

The beneficial effect of the present invention is primarily embodied in: the disinfectant of the present invention, under the condition of continuously introducing the air, can be used for a long time, without need of anti-viral drugs or antibiotics etc, and without need of the presence of a peroxide having hidden safety trouble, without use of an irritant substance containing halogen, and further without use of alcohol having explosive hazard. Such disinfectant system without use of precious metal is easy to prepare, and has low cost of use, does not cause the secondary pollution, and has a good application prospect.

### BRIEF DESCRIPTION OF THE DRAWINGS

FIG. 1 is an action mechanism of killing the microorganisms by oxygen in the air.

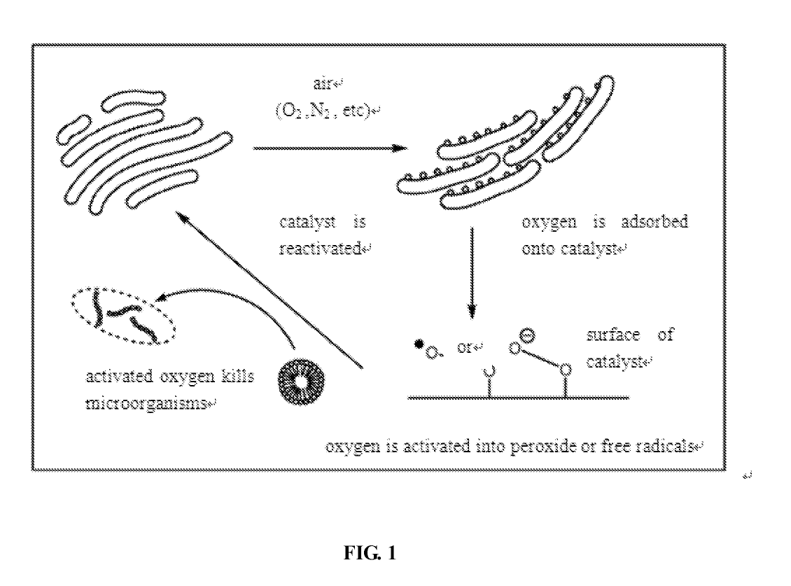

### DETAILED DESCRIPTION OF THE EMBODIMENTS OF THE INVENTION

Hereinafter, the present invention will be further described in conjunction with the specific embodiments, but the protection scope of the present invention is not limited to these.

### Example 1

Catalyst Screening

In catalyst screening, Staphylococcus aureus was used as the microorganisms, and a trypsin soybean agar was used as a culture medium. The material powder to be screened was prepared into a homogeneous mixture solution by pure water in a 3% weight/volume ratio (i.e., 3 g powder/100 mL water), then immersed with a neutral precise filtration filter paper of 5 mm diameter for about 10 seconds, then placed into a Kirby-Bauer diffusion detection plate. A Kirby-Bauer diffusion detection plate was placed in a sealed glass cover, and the air was provided into the glass cover at a speed of about 10 liters per minute. The sterilizing capability of the catalyst was measured by the diameter of the zone without bacterial growth around the filter paper.

The results showed that, thousands of non-traditional oxygen activators without strong oxidizability and inorganic salts having good water solubility without sterilization and disinfection capability were detected, only the polyoxometalates had the capability of catalytic activation of oxygen and killing viruses or pathogenic bacteria: for the polyoxometalates solution directly prepared by pure water, their inhibition zone diameters were all essentially greater than 13 mm, and for the other salts to be detected, the maximum inhibition zone diameters were all less than 5 mm. In case that the air was not introduced, the sterilization effect of polyoxometalates was poor, and the diameter of the inhibition zone was generally 3 to 5mm.

### Example 2

A variety of polyoxometalates were respectively prepared into a water solution with a 3% mass concentration, and pH was controlled to 10. The sterilizing capability was also detected by Kirby-Bauer diffusion detection method in which Staphylococcus aureus was used as the microorganisms, respectively including no oxygen ventilation and oxygen ventilation. When oxygen was ventilated, the condition for oxygen ventilation was the same, the temperature was room temperature (25° C.) and 37° C. The results are shown in Table 1, the results showed that when the concentration was 3%, at room temperature or somewhat higher, there was no significant difference in the sterilizing capability, indicating such disinfectant system was stable.

TABLE 1
Sterilization effects at different temperatures

| | sterilization | | |
|---|---|---|---|
| | effect without | sterilization | sterilization |
| | oxygen ventila- | effect at | effect at |
| | tion | 25° C. | 37° C. |
| polyoxometalates | (diameter, mm) | (diameter, mm) | (diameter, mm) |
| K₃[PW₁₂O₄₀] | 3 | 19 | 19 |
| Na₃[PW₁₂O₄₀] | 3 | 19 | 18 |
| (NH₄)₃[PW₁₂O₄₀] | 4 | 19 | 20 |
| Ca₃[PW₁₂O₄₀]₂ | 4 | 18 | 20 |
| K₅[PV₂Mo₁₀O₄₀] | 5 | 20 | 20 |
| Na₅[PV₂Mo₁₀O₄₀] | 4 | 19 | 20 |
| (NH₄)₅[PV₂Mo₁₀O₄₀] | 5 | 19 | 19 |

The results showed that the capabilities of catalytic activation of oxygen for disinfection by the polyoxometalates were all very good.

### Example 3

Potassium polytungstate (K₃[PW₁₂O₄₀]) was respectively prepared into water solutions with mass concentration of 0.5%, 1.0%, 2.0%, 3%, 5%, 10%, and 15%, and the pH were controlled to 10. The sterilizing capability was also detected by Kirby-Bauer diffusion detection method in which Staphylococcus aureus was used as the microorganisms, the condition for oxygen ventilation was the same, and the temperature was room temperature (25° C.) and 37° C. The results were shown in Table 2, the results showed that when the concentration was 5% or more, at room temperature or somewhat higher, there was no significant difference in the sterilizing capability.

TABLE 2
Sterilization effects at different concentrations and temperatures

| | sterilization | sterilization |
|---|---|---|
| concentration | effect at 25° C. | effect at 37° C. |
| (%) | (diameter, mm) | (diameter, mm) |
| 0.5 | 8 | 9 |
| 1.0 | 11 | 10 |
| 2.0 | 14 | 16 |
| 3.0 | 16 | 18 |
| 5 | 18 | 19 |
| 10 | 20 | 20 |
| 15 | 19 | 18 |

### Example 4

Relationship between the sterilizing capability and pH value of the polytungstate.

Potassium polytungstate (K₃[PW₁₂O₄₀]) was respectively prepared into water solutions with a concentration of 3% and pH of 6, 7, 8, 8.5, 9, 9.5, 10, 10.5, 11, 11.5, 12. The sterilizing capability was also detected by Kirby-Bauer diffusion detection method in which Staphylococcus aureus was used as the microorganisms, the condition for oxygen ventilation was the same, and the temperature was room temperature (25° C.) and 37° C. The results were shown in Table 3, the results showed that when the concentration was 3%, at room temperature or somewhat higher, and pH was 8 or more, the sterilizing capability was good, and when the pH was 10 or more the sterilizing capability was the best.

TABLE 3
Data table of the relationship between the sterilization
effect of potassium polytungstate and pH value.

| | sterilization | sterilization |
|---|---|---|
| | effect at 25° C. | effect at 37° C. |
| pH value | (diameter, mm) | (diameter, mm) |
| 6 | 5 | 6 |
| 7 | 6 | 8 |
| 8 | 8 | 11 |
| 8.5 | 14 | 15 |
| 9 | 17 | 18 |
| 9.5 | 20 | 19 |
| 10 | 19 | 19 |
| 10.5 | 18 | 19 |
| 11 | 20 | 20 |
| 11.5 | 20 | 20 |
| 12 | 20 | 20 |

### Example 5

Capability of Removing Formaldehyde by the Disinfectant

In the test, a sealed stainless steel box (0.7 m×0.7 m×0.7 m) was used as a detection space for formaldehyde, and the capability of removing formaldehyde was compared with an activated carbon. For two boxes for test, 500 ml of 3% polytungstate potassium water solution (pH=10) was put into one of the two boxes, and 500 grams of food-grade activated carbon was put into the other, using formaldehydemeter (PPM Formaldehydemeter 400, the resolution was 0.01 ppm), and change in formaldehyde concentration in the air with an initial formaldehyde concentration being 10 ppm was detected.

TABLE 3
Data table of decrease in concentration of formaldehyde in the air

| | effect of the | effect of the |
|---|---|---|
| time | polytungstate | activated |
| (hour) | potassium (ppm) | carbon (ppm) |
| 0 | 10 | 10 |
| 1 | 7.1 | 9.5 |
| 2 | 5.3 | 8.5 |
| 3 | 3.7 | 8.1 |
| 4 | 2.5 | 5.5 |
| 5 | 1.3 | 4.2 |

The results show that, the new disinfection system disclosed in the present invention had a better capability of adsorbing formaldehyde than the activated carbon, indicating that the disinfectant of the present invention will have a good application prospect in air purification field.

The aforementioned are only the preferred embodiments of the present invention, but they are not intended to limit the true scope of the present invention, the true scope of the present invention are broadly defined in the claims of the application, and techniques or methods accomplished by any other person, if they are exactly the same as defined by the claims of the application or an equivalent variation, are all deemed being covered by such claims.

1. A method of preparing a disinfectant comprising the step of utilizing polvoxometalates, wherein the anion of the polyoxometalates is [PM/₁₂O₄₀]³⁻ or [PV₂Mo₁₀O₄₀]⁵⁻, and the cation is alkaline metal ion, alkaline earth metal ion, transition metal ion or ammonium ion.

2. The method according to claim 1, wherein the cation of the polyoxometalates is one of the following: potassium ion, sodium ion, ammonium ion, calcium ion, magnesium ion, copper ion, and iron ion.

3. The method according to claim 1, wherein the disinfectant is a base solution prepared by evenly dispersing the polyoxometalates into water as a solvent, the pH is 8 to 12, and an effective disinfection effect is obtained in the presence of oxygen; the solvent is water, glycerol or a mixture thereof; the mass concentration of polyoxometalates in the base solution is 0.5% to 15%.

4. The method according to claim 3, wherein the pH value of the base solution is 9.5 to 11, and the mass concentration of polyoxometalates in the base solution is 1% to 5%.

5. The method according to claim 1, wherein the disinfectant is added to an air purifier, for sterilizing or removing the formaldehyde.

6. The method according to claim 1, wherein the base solution also comprises additives.

7. The method according to claim 1, wherein the disinfectant is prepared to a liquid, a slurry-like paste or a solid product.

8. A method of disinfecting an object, comprising the step of applying to the object a disinfectant comprising polyoxometalates, wherein the anion of the polyoxometalates is [PW₁₂O₄₀]³⁻ or [PV₂Mo₁₀O₄₀]⁵⁻, and the cation is alkaline metal ion, alkaline earth metal ion, transition metal ion or ammonium ion.

9. The method according to claim 8, wherein the cation of the polyoxometalates is one of the following: potassium ion, sodium ion, ammonium ion, calcium ion, magnesium ion, copper ion, and iron ion.

10. The method according to claim 8, wherein the disinfectant is a base solution prepared by evenly dispersing the polyoxometalates into water as a solvent, the pH is 8 to 12, and an effective disinfection effect is obtained in the presence of oxygen;
the solvent is water, glycerol or a mixture thereof; the mass concentration of polyoxometalates in the base solution is 0.5% to 15%.

11. The method according to claim 8, wherein the pH value of the base solution is 9.5 to 11, and the mass concentration of polyoxometalates in the base solution is 1% to 5%.

12. The method according to claim 8, wherein the disinfectant is added to an air purifier, for sterilizing or removing the formaldehyde.

13. The method according to claim 8, wherein the base solution also comprises additives.

14. The method according to claim 8, wherein the disinfectant is prepared to a liquid, a slurry-like paste or a solid product.

15. A disinfectant comprising polyoxometalates, wherein the anion of the polyoxometalates is [PW₁₂O₄₀]³⁻ or [PV₂Mo₁₀O₄₀]⁵⁻, and the cation is alkaline metal ion, alkaline earth metal ion, transition metal ion or ammonium ion.

16. The disinfectant according to claim 15, wherein the cation of the polyoxometalates is one of the following: potassium ion, sodium ion, ammonium ion, calcium ion, magnesium ion, copper ion, and iron ion.

17. The disinfectant according to claim 15, wherein the disinfectant is a base solution prepared by evenly dispersing the polyoxometalates into water as a solvent, the pH is 8 to 12, and an effective disinfection effect is obtained in the presence of oxygen; the solvent is water, glycerol or a mixture thereof; the mass concentration of polyoxometalates in the base solution is 0.5% to 15%.

18. The disinfectant according to claim 15, wherein the pH value of the base solution is 9.5 to 11, and the mass concentration of polyoxometalates in the base solution is 1% to 5%.

19. The disinfectant according to claim 15, wherein the disinfectant is added to an air purifier, for sterilizing or removing the formaldehyde.

20. The disinfectant according to claim 15, wherein the base solution also comprises additives.
